(19) United States
(12) Patent Application Publication
(10) Pub. No.: US 2013/0072371 A1
(43) Pub. Date: Mar. 21, 2013

(54) METHOD OF, AND APPARATUS FOR, USING A GLASS FLUXING AGENT TO REDUCE FOAM DURING MELTING OF GLASS BATCH

(71) Applicants: Lawrence E. Jansen, Burkburnett, TX (US); Rodney K. Dunn, Devol, OK (US); Robert E. Eakin, Wichita Falls, TX (US); Gerald DiGiampaolo, Kerrville, TX (US)

(72) Inventors: Lawrence E. Jansen, Burkburnett, TX (US); Rodney K. Dunn, Devol, OK (US); Robert E. Eakin, Wichita Falls, TX (US); Gerald DiGiampaolo, Kerrville, TX (US)

(73) Assignee: PPG INDUSTRIES OHIO, INC., Cleveland, OH (US)

(21) Appl. No.: 13/418,893

(22) Filed: Mar. 13, 2012

Related U.S. Application Data
(60) Provisional application No. 61/453,575, filed on Mar. 17, 2011.

(51) Int. Cl. C03B 5/225; C03C 3/00

(52) U.S. Cl. CPC C03B 5/225; C03C 3/00
USPC 501/11; 65/134.9; 65/134.5; 65/347

(57) ABSTRACT

A foam and frothy glass mixture that forms on a pool of molten glass and inhibits heat transfer between the overhead flames and the pool of molten glass is decreased, if not eliminated, by spreading a glass fluxing agent, e.g. but not limiting to the invention, sodium sulfate over the foam and/or frothy glass mixture.

### CROSS REFERENCE TO RELATED APPLICATION

This application claims the benefits of U.S. Provisional Patent Application Ser. No. 61/453,575 filed Mar. 17, 2011 and titled “GLASS FLUXING AGENT AND METHOD OF USING SAME TO REDUCE FOAM IN A GLASS MELTING FURNACE”. Application Ser. No. 61/453,675 in its entirety is incorporated herein by reference.

### BACKGROUND OF THE INVENTION

1. Field of the Invention

The invention relates to a method of, and apparatus for, using a glass fluxing agent to reduce foam during melting of glass batch, and more particularly, to spreading sulfate, e.g. sodium sulfate over a foam and/or frothy glass mixture that forms on the molten glass after melting the glass batch materials to reduce, if not eliminate, the foam and/or frothy glass mixture.

2. Discussion of the Technical Problem

In a glass melting furnace of the continuous type, a body of molten glass is maintained in the furnace and raw glass batch materials are fed through an inlet at one end of the furnace onto the surface of the pool of molten glass. There, the batch materials form an unmelted layer or “blanket” on the surface of the molten glass pool, which can extend a considerable distance into the furnace until it becomes melted into the poor of molten glass. Heat for melting the batch materials is provided within the furnace by the radiant heat generated by combustion burners above the level of the molten glass, sometimes aided by submerged electric heating facilities. At the opposite end of the furnace from the inlet end, melted glass is withdrawn from the pool of molten glass through an outlet opening. Between the melting area of the furnace where the glass batch materials are heated and melted, and the outlet opening is the fining area of the furnace where the molten glass is fined, i.e. the molten glass is homogenized, and gas bubbles in the molten glass eliminated.

As the glass batch materials move on the molten glass toward the outlet opening of the furnace, the batch materials continue to melt. After the batch materials are completely melted, a foam and/or frothy glass mixture (hereinafter also referred to as an “undesired mixture”) often forms on the molten glass. Moderate amounts of the undesired mixture usually melt before the outlet end of the furnace is reached; however, excessive amounts of the undesired mixture can remain on the molten glass pool as the glass moves through the fining area of the furnace and though the outlet opening. As can be appreciated by those skilled in the glassmaking art, when the undesired mixture exits the outlet opening of the furnace, the subsequently formed glass ribbon has a silica enriched surface that contains numerous bubble defects formed by the solidification of the foam and/or frothy glass mixture on the surface of the glass ribbon.

As previously mentioned, moderate amounts of the undesired mixture melt before the mixture reaches the outlet opening. Even though the undesired mixture melts before reaching the outlet opening, the presence of the undesired mixture is a drawback to the glass melting process. For a more detailed discussion of the drawback, the discussion starts at the inlet end of the furnace. The raw glass batch materials or batch blanket on the molten glass at the inlet end of the furnace is relatively cold and acts as a heat sink. Further, the heated and melting glass batch materials, and the undesired mixture on the molten glass shields the underlying portion of the molten glass pool from the radiant heat. More particularly, the melting batch materials, and the undesired mixture present on the molten glass surface significantly inhibits heat transfer between the overhead flames and the molten glass. Further, the undesired mixture reflects heat from the flames off its surface to the refractory structure of the furnace interior. This causes higher refractory temperatures for the furnace roof or crown and lower molten glass temperatures. The lower molten glass temperatures inhibit the complete elimination of bubbles by limiting heat transfer into the glass in the fining area.

Technology is available to overcome the problems of the glass batch materials acting as a heat sink and a shield, e.g. see U.S. Pat. No. 4,544,396, which patent is hereby incorporated by reference. Unfortunately, there is no present solution for eliminating the foam and/or frothy glass mixture on the molten glass to eliminate the drawbacks associated with the undesired mixture on the molten glass.

As can be appreciated by those skilled in the glassmaking art reducing or eliminating the foam and frothy glass mixture after the glass batch is melted will maximize radiant heat transfer from the combustion flames into the molten glass in the fining area and minimizes over heating of the refractory structure allowing more heat transfer from the refractory into the molten glass.

### SUMMARY OF THE INVENTION

This invention relates to a method of reducing a foam and frothy glass mixture forming on a pool of molten glass in a furnace, the furnace including a feeding end, an outlet end and a position between the inlet end and the outlet end where raw glass batch materials moved into the inlet end of the furnace are melted as they move toward the outlet end, wherein the foam and frothy glass mixture forms on the pool of molten glass, the method is practiced by, among other things, spreading a glass fluxing agent over the foam and frothy glass mixture to collapse the foam and frothy glass mixture.

The invention further relates to a glass article made from the molten glass.

The invention still further relates to a device for spreading a glass fluxing agent over a foam and frothy glass mixture forming on a pool of molten glass, the device includes, among other things, a spreading horn, and a pressurized feeding arrangement to move the fluxing agent through the spreading horn at a preselected pressure as a spray of particles.

In addition, the invention relates to an improved glass melting furnace. The melting furnace that is improved includes, among other things, a feeding end, an outlet end and a position between the inlet end and the outlet end where raw glass batch materials moved into the inlet end of the furnace are melted, wherein a foam and frothy glass mixture forms on the pool of molten glass. The improvement includes, among other things, a spreading horn mounted in outer walls of the furnace, and a pressurized system for moving particles of a glass fluxing agent over an area of the furnace where the foam and frothy glass mixture is expected to form.

### BRIEF DESCRIPTION OF THE DRAWINGS

FIG. 1 is a vertical cross-section through a typical cross-fired, end-fed, glass melting furnace incorporating features of the invention.

FIG. 2 is a plan view of the lower portion of the furnace of FIG. 1 taken along line 2-2.

FIG. 3 is an isometric view of an apparatus incorporating features of the invention for spreading glass fluxing agent to reduce, if not eliminate, the foam and frothy glass mixture according to the teachings of the invention.

FIGS. 4-6 are block diagrams showing supplies to operate the apparatus of FIG. 3 in accordance to the teachings of the invention.

### DETAILED DESCRIPTION OF THE INVENTION

As used herein, unless otherwise expressly specified, all numbers such as those expressing values, ranges, amounts or percentages are read as if prefaced by the word “about”, even if the term does not expressly appear. When referring to any numerical range of values, such ranges are understood to include each and every number and/or fraction between the stated range minimum and maximum. For example, a range of “1 to 10” is intended to include all sub-ranges between and including the recited minimum value of 1 and the recited maximum value of 10, that is, having a minimum value equal to or greater than 1 and a maximum value of equal to or less than 10. As employed herein, the term “number” means one or an integer greater than one.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise, in the following discussion like numbers refer to like elements.

The non-limiting embodiments of the invention discussed herein are directed to the process of making glass which includes, but is not limited to, melting raw glass batch materials, fining the molten glass and making a glass ribbon by floating molten glass on a metal bath. The invention, however, is not limited to the raw batch materials, and the invention can be practiced with any process for making any glass product where the melting of glass batch material results in the formation of foam and/or frothy glass mixture (hereinafter also referred to as an “undesired mixture”) on molten glass. As used herein the terms “foam and/or frothy glass mixture” and “undesired mixture” means “a stable multiple layer of non-collapsed gas bubbles entrapped in the liquid molten glass that is supported on the top surface of the pool of molten glass in the glass melting furnace”.

A typical glass melting furnace to which the present invention relates can be characterized by an inlet end at which raw glass batch materials are deposited onto a pool of molten glass held in the furnace and a generally opposite outlet end from which a product stream of molten glass is withdrawn from the pool. A specific embodiment of the invention is described herein in the context of a common type of glass melting furnace in which the primary source of heat for melting is a plurality of flames extending transversely above the molten glass pool from ports in the side walls. It should be understood that other configurations of glass melting furnace are also commonly used and can also benefit from the present invention.

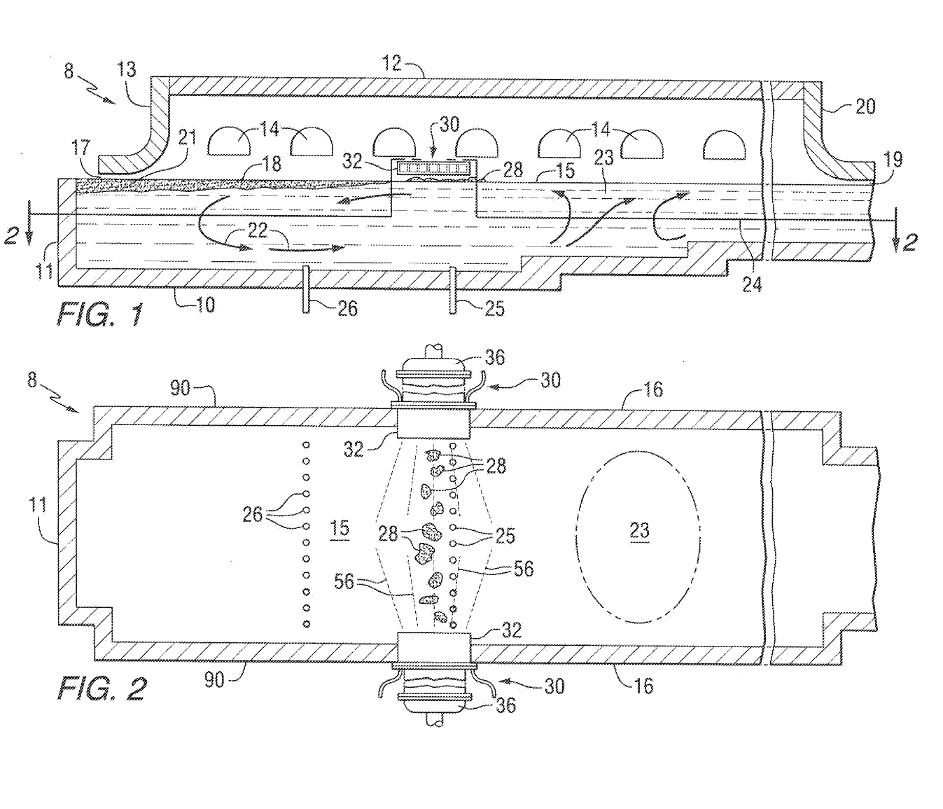

Referring to FIG. 1, typical glass melting furnace 8 depicted includes a refractory basin bottom wall 10, basin inlet end wall 11, an arched roof 12, a suspended back wall 13, and a plurality of side firing ports 14. The number of ports can vary; typical flat glass furnaces usually have five to eight ports on each side. The basin of the furnace contains a pool of melting glass 15. Side basin walls 16 are shown in FIG. 2, Batch materials 21 are fed onto the pool 15 through an inlet opening 17 and form a layer or batch cover 18 that melts as it progresses into the furnace. Molten glass passes from the furnace through an outlet opening 19 at an exit end of the furnace partly defined by an exit end wall 20.

The circulation currents in the pool of molten glass 15 are shown in FIG. 1. The presence of relatively cold batch material at the inlet end 17 of the furnace and the shielding of the pool of molten glass 16 from the overhead flames by the layer of batch 18, cause downward convection currents 22 in the inlet region of the pool 15. The hottest region in the pool of molten glass 15 tends to be located downstream from the end of the batch layer 18, typically opposite the last or next-to-last port 14. The high temperatures in this region 23 known as the “spring zone” or “hot spot” generate rising convection currents in the pool 15. The combination of the rising and descending convection currents produces a circulation cell in the region upstream from the spring zone 23 which, as viewed in FIG. 1, moves in a generally counter-clockwise direction, with flow in the upper portion moving in an upstream direction (La, toward the inlet 17) and with flow in the bottom portion moving in the downstream direction (i.e., toward the outlet 19). Downstream from the spring zone 23 a circulation cell 24 rotating in the opposite direction can be present.

Although not limiting to the invention, a plurality of bubbler tubes 25 can be provided to enhance the circulation, and to carry out redox changes within the melting furnace as disclosed in U.S. Pat. No. 5,006,144, which patent is hereby incorporated by reference. The bubblers 25 and 26 are shown in a straight row extending substantially across the width of the furnace in the drawings, but it should be understood that the invention is not limited to the number of bubbler rows, or the number of bubblers in the row that can be used in the practice of the invention and that the bubblers can be arranged in any arrangement, e.g. but not limited to the invention in a linear row as shown in FIG. 2. Further, the invention can be practiced on a glass melting furnace having no bubblers.

Usually the furnace heating pattern is designed such that the glass batch materials are completely melted prior to passing through the area of the furnace having the bubblers. Generally in the area of the furnace having the bubblers 25, the glass batch materials are completely melted and a foam and frothy glass mixture or undesired mixture 28 forms on the pool of molten glass 15. In a furnace having no bubblers, the foam and frothy glass mixture 28 generally forms in an area about 1-5 feet downstream of the end of the batch melt. As can be appreciated, the invention is practiced in the area of the glass melting furnace where the undesired mixture 28 is floating on the pool 15. More particularly, in the practice of the invention a chemical glass fluxing agent is spread over the undesired mixture 28 to collapse the undesired mixture. The glass fluxing agent is spread over the undesired mixture 28 at a location in the furnace that does not upset the flow or quality of the glass. In one non-limiting embodiment of the invention, the location in which the invention was practiced was the area of the furnace having the bubblers 25, e.g. a position upstream of the spring zone 23 and downstream of the end of the batch melt.

Chemical glass fluxes that can be used in the practice of the invention, but not limiting the invention thereto, include salts of sodium, e.g. sodium sulfate, sodium chloride, sodium carbonate and mixtures thereof. Salts of sodium are preferred in the practice of the invention because sodium is an essential component of glass, and the addition of the salts of sodium should not materially change the properties of the glass product being made. Further, in the preferred practice of the invention, but not limiting thereto, the preferred chemical glass fluxer is sodium sulfate, also known as salt cake. More particularly, experimental runs were made using sodium sulfate, sodium chloride and sodium carbonate, and the best results, e.g. less time to decrease the amount of the undesirable mixture 28 on the molten glass, and a longer time period for the undesirable mixture 28 to appear on the molten glass were realized using sodium sulfate. As can now be appreciated, the invention is not limited to sodium sulfate and other types of sulfate, e.g. but not limited to calcium sulfate and magnesium sulfate can be used in the practice of the invention provided they are compatible with the glass making process.

The invention contemplates using sodium sulfate to decrease or eliminate the undesirable mixture 28 without reducing the weight percent (“wt %”) of sodium sulfate in the batch materials, and contemplates using sodium sulfate to decrease or eliminate the undesirable mixture 28 and reducing the weight percent of sodium sulfate in the batch materials. More particularly, when the additions of the sodium sulfate are made to collapse the undesired mixture 28, a reduction of the sodium sulfate to the glass batch materials 21 moved into the inlet end 17 of the furnace 8 can be made. Usually for each addition of the sodium sulfate made to collapse the undesired mixture, a 15-35%, preferably a 20-30%, and more preferably a 25%, reduction of the sodium sulfate is made to the raw glass batch materials 21. By way of illustration and not limiting to the invention, for a use of 10 pounds of sodium sulfate, i.e. salt cake to reduce or eliminate the undesired mixture, a 2.5 pounds reduction of salt cake was made to the raw glass batch materials. In the experiment conducted, no reduction to the salt cake of the batch materials was made, and the glass made maintained it high quality.

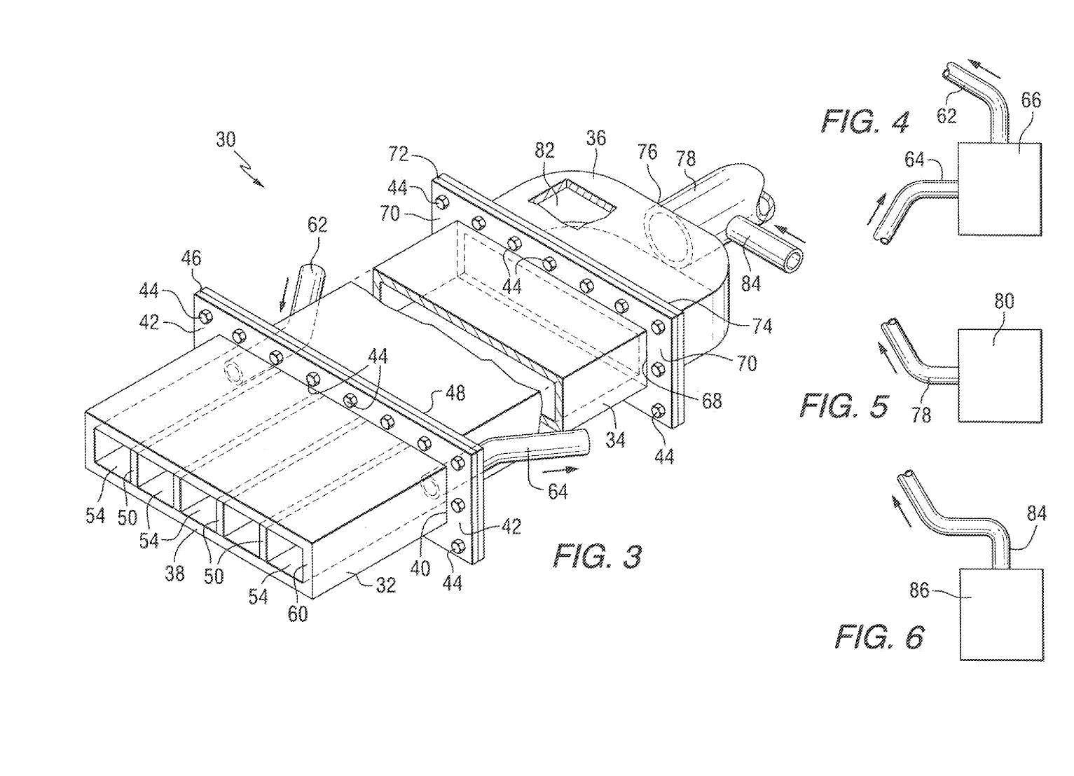

The invention is not limited to the apparatus or method of applying the glass flux agent over the undesired mixture and any spreading apparatus or spreading technique can be used in the practice of the invention. In one non-limited embodiment of the invention, a spreading device 30 clearly shown in FIG. 3 was used to practice the invention. The spreading device 30 included a spreading horn 32, a feeding conduit 34 and a pressurized feeding device 36. The spreading horn 32 had an outlet end 38 and an inlet end 40. The inlet end 40 of the spreading horn 32 had a flange 42 connected by nut and bolt assemblies 44 to a flange 46 at an outlet end 48 of the feeding conduit 34. Interior of the spreading horn 32 had a plurality of spaced baffles 50 to provide the interior of the horn with passageways 54 through which the sodium sulfate was forced. The sodium sulfate exited the outlet end 38 of the spreading horn 32 in the form of a spray 56 (see FIG. 2) and was spread over the undesired mixture 28. The sodium sulfate had a grain size in the range of 20 mesh (0.841 mm) to 200 mesh (0.074 mm).

With reference to FIGS. 3-6 as needed, a water-cooled jacket 60 surrounded the passageways 54 of the spreading horn 32. The water-cooled jacket 60 was connected by inlet conduit 62 and by outlet conduit 64 to a water chilling device 66 (see FIG. 4). The chilled water passed from the chilling device 66 through the inlet conduit 62 and through the water cooled jacket 60. The heated water passed out of the water-cooled jacket 60 through the outlet conduit 64 to the chilling device 66. The heated water was cooled by the chilling device 66 and passed through the conduit 62 to the spreading horn 32.

With reference to FIGS. 3-6 as needed, net end 68 of the feeding conduit 34 had a flange 70 connected to a flange 72 on outlet end 74 of the pressurized feeding device 36 by the nut and bolt assemblies 44. Inlet end 76 of the pressurized feeding device 36 was connected by a conduit 78 to a device 80 (see FIG. 5) for supplying sodium sulfate to a chamber 82 of the feeding device 34. The chamber 82 of the feeding device 36 was connected by conduit 84 to a pressurized air supply 86 (see FIG. 6). With this arrangement, sodium sulfate was moved by the device 80 into the chamber 82 of the feeding device 36 and pressurized air from the supply 86 was moved through the conduit 84 into the chamber 82 to blow the sodium sulfate through the chamber 82, through the feeding conduit 34, through the passageways 54 of the spreading horn 32 over the undesired mixture 28 to collapse the undesired mixture.

In the practice of the invention, the spreading horn 32 of the spreading device 30 was mounted through each of the wails 16 of the glass furnace 8 with the flange 42 of the spreading horn biased against outer surface 90 of the outer walls 16 of the furnace. The feeding conduit 34 was engaged to support the spreading device 30 and to bias the flange 42 of the spreading horn against the outer surface 90 of the wails 16. The spreading horn was positioned between the end of the batch melt and the spring zone 23. In one non-limited embodiment of the invention, the spreading horn 32 had 6 square openings 54, with each side of the square openings 54 measuring 2 inches, and the spreading horn 32 had a length of 2 inches. The sodium sulfate was moved through the spreading device 30 under an air pressure of 50 pounds per square inch, which was sufficient to cover a distance of 17 feet from the furnace wall 16.

In one experimental run, a glass furnace was producing 25 tons of molten glass per hour. For a period of 1.5 hours after the start of the experimental run, one pound of sodium sulfate per minute was spread over the undesired mixture 28. The undesired mixture 28 collapsed and was mixed with the molten glass. The undesirable mixture was observed 5 minutes after the experimental run was completed. As mentioned earlier, experimental runs were made using sodium chloride and sodium carbonate, and the best results were realized using sodium sulfate.

As can be appreciated by those skilled in the glassmaking art, practicing the invention to reduce or eliminate the foam and frothy glass mixture maximizes radiant heat transfer from the combustion flames into the molten glass in the fining area and minimizes over heating of the refractory structure allowing more heat transfer from the refractory into the molten glass.

The invention is not limited to the embodiments of the invention presented and discussed above which are presented for illustration purposes only, and the scope of the invention is only limited by the scope of the following claims and any additional claims that are added to applications having direct or indirect linage to this application.

What is claimed is:

1. A method of reducing a foam and frothy glass mixture forming on a pool of molten glass in a furnace, the furnace comprising a feeding end, an outlet end and a position between the inlet end and the outlet end where raw glass batch materials moved into the inlet end of the furnace are melted as they move toward the outlet end, wherein the foam and frothy glass mixture forms on the pool of molten glass, the method comprising;
spreading a glass fluxing agent over the foam and frothy glass mixture to collapse the foam and frothy glass mixture.

2. The method according to claim 1 wherein the glass fluxing agent includes sulfate.

3. The method according to claim 1 wherein the glass fluxing agent is a salt of sodium.

4. The method according to claim 3 wherein the salt of sodium is selected from the group of sodium sulfate, sodium chloride, sodium carbonate and mixtures thereof.

5. The method according to claim 1 wherein the spreading a glass fluxing agent is practiced at a position in the furnace where convection currents in the molten glass move in a counterclockwise direction.

6. The method according to claim 1 wherein the spreading a glass fluxing agent is accomplished by moving the glass fluxing agent through a spreading device.

7. The method according to claim 1 wherein the spreading a glass fluxing agent is accomplished by moving the glass fluxing agent through a spreading device at a rate of one pound per minute.

8. The method according to claim 2 wherein the raw glass batch materials are selected to make a soda-lime-silicate glass having a predetermined weight percent of the salt of sodium, wherein a first portion of the salt of sodium having a weight percent greater than zero is added to the raw glass batch materials and a second portion of the salts of sodium having a weight percent greater than zero is added during the practice of the spreading salts of sodium wherein the first portion and the second portion of the salts of sodium make up the predetermined amount of the salts of sodium.

9. The method according to claim 8 wherein for every 10 pounds of the second portion of the salt of sodium, the first portion of the salt of sodium is reduced by 2.5 pounds.

10. The method according to claim 2 wherein the sulfate is selected from the group of sodium sulfate, calcium sulfate and magnesium sulfate.

11. The method according to claim 1 wherein the furnace includes a plurality of bubblers extending upward from a floor of the furnace and the step of spreading a glass fluxing agent is practiced over the bubblers.

12. The method according to claim 1 wherein the molten glass in the furnace includes a spring zone furnace and the step of spreading a glass fluxing agent is practiced upstream of the spring zone and downstream of an end of the batch melt.

13. A glass article made from the glass made according to the method of claim 1.

14. A device for spreading a glass fluxing agent over a foam and frothy glass mixture forming on a pool of molten glass, the device comprising:
a spreading horn, and
a pressurized feeding arrangement to move the fluxing agent through the spreading horn at a preselected pressure as a spray of particles.

15. The device according to claim 11, wherein the spreading horn comprises a housing having a plurality of passageways through which the fluxing agent is moved.

16. The device according to claim 11 wherein the fluxing agent is includes a sulfate.

17. In a glass melting furnace comprising a feeding end, an outlet end and a position between the net end and the outlet end where raw glass batch materials moved into the net end of the furnace are melted, wherein a foam and frothy glass mixture forms on the pool of molten glass, the improvement comprising:
a spreading horn mounted in outer walls of the furnace, and
a pressurized system for moving particles of a glass fluxing agent over an area of the furnace where the foam and frothy glass mixture is expected to form.

18. The improved glass melting furnace of claim 17 comprising a water cooled jacket over end of the spreading horn over the pool of molten glass.
